(19) United States
(12) Patent Application Publication
(10) Pub. No.: US 2005/0239313 A1
(43) Pub. Date: Oct. 27, 2005

(54) Reinforcement of electrical connections in electronic devices

(75) Inventors: Long V. Nguyen, San Jose, CA (US); Yi-Ming Tseng, Palo Alto, CA (US)

Correspondence Address: MICHAEL B. EINSCHLAG, ESQ., 25680 FERNHILL DRIVE, LOS ALTOS HILLS, CA, 94024, US

(73) Assignee: Riospring, Inc., Milpitas, CA (US)

(21) Appl. No.: 11/108,562

(22) Filed: Apr. 18, 2005

Related U.S. Application Data
(60) Provisional application No. 60/564,343, filed on Apr. 21, 2004.

(51) Int. Cl. H01R 11/22

(52) U.S. Cl. 439/331

(57) ABSTRACT

One embodiment of the present invention is an electronic device that includes: (a) a connector; (b) a contact pad; and (c) a structure adapted to urge the connector toward the contact pad, wherein at least a portion of the structure is aligned with at least a portion of the connector.

This application claims the benefit of U.S. Provisional Application No. 60/564,343, filed on Apr. 21, 2004 and which is incorporated herein by reference.

### TECHNICAL FIELD OF THE INVENTION

One or more embodiments of the present invention relate to electronic devices, and more particularly, to reinforcement of electrical connections in electronic devices.

### BACKGROUND OF THE INVENTION

Small form factor electronic devices, for example and without limitation, small hard disk drives, utilize small, thin printed circuit boards (PCBs). Considering hard disk drives as an example, this poses mechanical structural stability and electrical connection issues for PCBs related to printed circuit board assembly and use. Such issues are particularly important for connector components such as, for example and without limitation, compression connectors consisting of multiple contact elements (typically, 16 or 18 contact elements). FIG. 1 shows a typical such compression connector mounted on a PCB board (i.e., compression connector 10 having sixteen (16) spring contacts 11) that is used to communicate with read/write heads contained within a small, hard disk drive.

As is well known, adequate force needs to be applied to a PCB to provide reliable electrical contact between contacts of a compression connector mounted on the PCB and further circuitry. In the prior art, the force is generated typically by an arrangement wherein: (a) a PCB mounting screw applies a force to a PCB substrate upon which the connector is mounted; and (b) the PCB substrate, in turn, transmits the force generated by the mounting screw to the contacts of the connector. As one can readily appreciate, the effectiveness of this arrangement depends on the stiffness of the PCB substrate. Because a typical PCB substrate used in a small form factor hard disk drive is so thin, it is typically not stiff enough to ensure reliable electrical contact. Further, without sufficient force urging spring contacts 11 of connector 10 shown in FIG. 1 towards contact pads such as, for example and without limitation, contact pads on a flex-cable assembly, the resulting electrical connections may be unreliable. As a result, the disk drive itself may operate in an unreliable manner.

In light of the above, there is a need in the art for an electronic device that solves one or more of the above-identified problems.

### SUMMARY OF THE INVENTION

One or more embodiments of the present invention solve one or more of the above-identified problems. In particular, one embodiment of the present invention is an electronic device that includes: (a) a connector; (b) a contact pad; and (c) a structure adapted to urge the connector toward the contact pad, wherein at least a portion of the structure is aligned with at least a portion of the connector.

### BRIEF DESCRIPTION OF THE DRAWING

FIG. 1 shows a typical compression connector mounted on a printed circuit board (PCB);

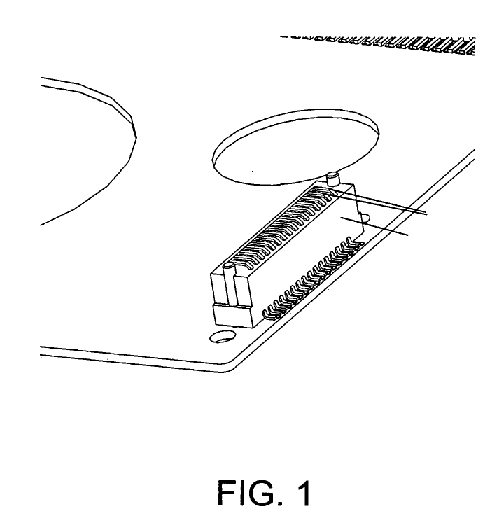

FIG. 2 shows a top view and a bottom view of a PCB cover of a disk drive that is fabricated in accordance with one or more embodiments of the present invention;

FIG. 3 shows top and bottom perspective exploded views of a disk drive which indicate relative positions of a PCB cover, a PCB, and a head disk assembly (HDA) of the disk drive, which disk drive is fabricated in accordance with one or more embodiments of the present invention;

FIGS. 4A and 4B show a top view and a cross-sectional view, respectively, of an assembly of the PCB cover, the PCB, and the HDA shown in FIG. 3;

FIG. 5 shows top and bottom perspective exploded views of a disk drive which indicate relative positions of a PCB cover, a PCB that includes a reinforcement unit, and an HDA of the disk drive, which disk drive is fabricated in accordance with one or more further embodiments of the present invention; and

FIGS. 6A and 6B show a top view and a cross-sectional view, respectively, of an assembly of the PCB cover, the PCB, and the HDA shown in FIG. 5.

### DETAILED DESCRIPTION

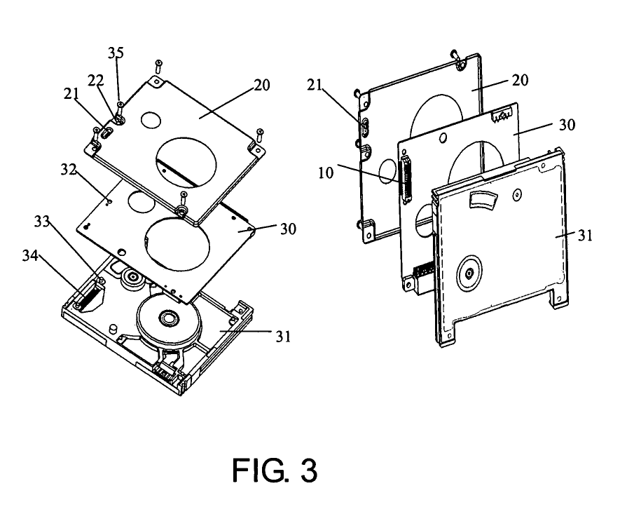

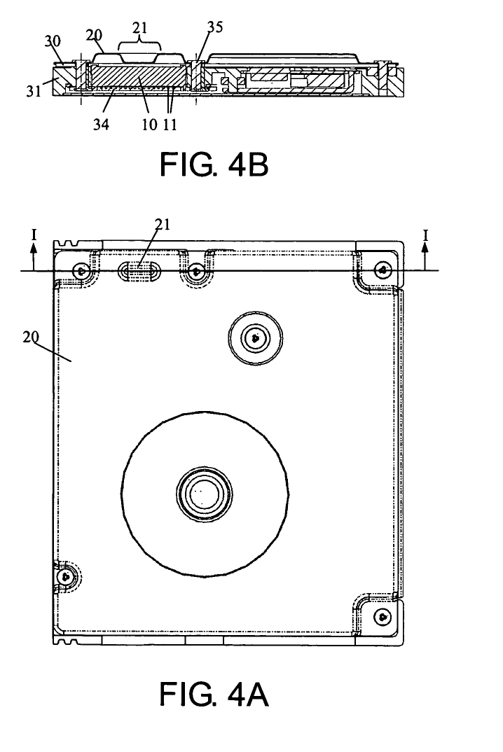

FIG. 3 shows top and bottom perspective exploded views of a disk drive which indicate relative positions of printed circuit board cover 20 (PCB cover 20), printed circuit board 30 (PCB 30), and head disk assembly 31 (HDA 31) of the disk drive, which disk drive is fabricated in accordance with one or more embodiments of the present invention. FIGS. 4A and 4B show a top view and a cross-sectional view, respectively, of an assembly of PCB cover 20, PCB 30, and HDA 31 shown in FIG. 3. As shown in FIGS. 3 and 4B, PCB 30 is disposed relative to HDA 31 so that connector 10 (on PCB 30) faces flex-cable assembly 34; and PCB cover 20 is disposed relative to PCB 30 so that raised reinforcement feature 21 (on PCB 20) extends towards PCB 30 and is disposed over, and on the opposite side of PCB 30 from, connector 10. As one can appreciate from FIG. 3, to assemble the parts shown therein, screw 35 would be: (a) extended through PCB cover screw hole 22 (in PCB cover 20) and PCB screw hole 32 (in PCB 30); and (b) screwed into HDA screw receptacle 33 (in HDA 31). As a result, PCB cover 20, PCB 30, and HDA 31 would be fastened together and properly aligned. Hence, as one of ordinary skill in the art can readily appreciate, in accordance with one or more embodiments of the present invention, during assembly of the disk drive, as screw 35 is tightened, it will exert a force on PCB cover 20. Further, this force would urge raised reinforcement feature 21 toward PCB 30. Still further, and as will be explained in detail below, raised reinforcement feature 21 is designed so that such urging would cause it to engage PCB 30 which, in turn, would be urged toward HDA 31. As a result, raised reinforcement feature 21 causes compression connector 10 to be urged towards flex-cable assembly 34 on HDA 31. Hence, in accordance with one or more embodiments of the present invention, a force applied by screw 35 is transmitted by raised reinforcement feature 21 to PCB 30 at an area of contact between raised reinforcement feature 21 and PCB 30. Without this force, it is believed that spring contacts 11 of compression connector 10 (refer to FIG. 4B) would tend to push compression connector 10 away from flex-cable assembly 34, thereby reducing contact between spring contacts 11 and contact pads of flex-cable assembly 34, and causing unreliable electrical connections.

Although the method of assembling PCB cover 20, PCB 30, and HDA 31 was described above as utilizing one screw and a corresponding set of screw holes, embodiments of the present invention are not limited thereto. For example, in accordance with one or more embodiments of the present invention, and as shown in FIGS. 3, 4A, and 4B, a plurality of screws, screw holes, and screw receptacles (like screw 35, screw holes 22 and 32, and screw receptacle 33) may be used in assembling the disk drive.

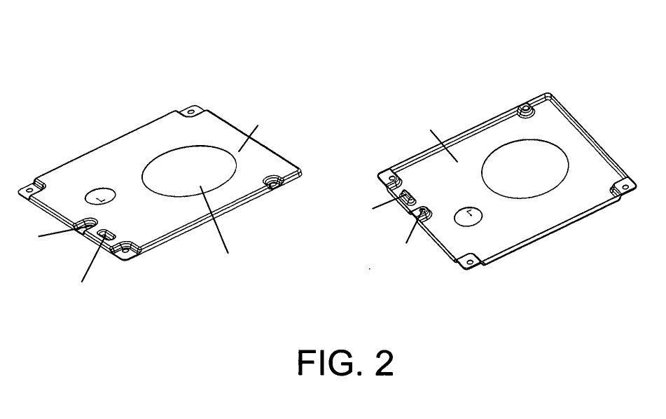

FIG. 2 shows a top view and a bottom view of printed circuit board cover 20 (PCB cover 20) of a disk drive that is fabricated in accordance with one or more embodiments of the present invention. In accordance with one such embodiment, PCB cover 20 is fabricated from a material having sufficient stiffness to enable it to transmit sufficient force to raised reinforcement feature 21 to provide the functionality described above. For example and without limitation, the material may be stainless steel, aluminum, or steel with nickel plating for protection against corrosion. Further, to be used in fabricating PCB 20, the material may be processed using one or more processes well known in the art such as, for example and without limitation, cold rolling, to form a thin-sheet. It should be understood that one of ordinary skill in the art may readily determine other materials for use in fabricating further embodiments of the present invention that have an appropriate amount of stiffness for a particular application routinely and without undue experimentation. As shown in FIG. 2, in accordance with one or more embodiments of the present invention, PCB cover 20 comprises raised reinforcement feature 21 as an integral part of PCB cover 20 (for example and without limitation, fabricated from stainless steel). It should be understood that one of ordinary skill in the art may readily determine other structures useful as raised reinforcement feature 21 for a particular application routinely and without undue experimentation, and that raised reinforcement feature 21 may be fabricated utilizing one or more methods that are well known to one of ordinary skill in the art such as, for example and without limitation, conventional metal forming or stamping processes. As further shown in FIG. 2, in accordance with one or more embodiments of the present invention, PCB cover 20 further comprises PCB cover screw hole 22 and optional opening 23. Optional opening 23 is fabricated in accordance with one or more embodiments of the present invention to accommodate one or more features of head drive assembly 31 (HDA 31) shown in FIG. 3. Further, PCB cover screw hole 22 and opening 23 may be fabricated utilizing one or more methods that are well known to one of ordinary skill in the art such as, for example and without limitation, conventional metal forming or cutting processes.

In accordance with one or more alternative embodiments of the present invention, PCB cover 20 may be fabricated of non-conductive material (for example and without limitation, a plastic material), and raised reinforcement feature 21 may be fabricated as an integral part of PCB cover 20 by molding with heat treatment in accordance with any one of a number of methods that are well known to those of ordinary skill in the art.

In accordance with one or more embodiments of the present invention, when the disk drive is assembled, at least a portion of raised enforcement feature 21 (referred to herein as an area of contact, although it could be several such areas) is aligned to be disposed over at least a portion of connector 10. In particular, in accordance with one or more embodiments of the present invention, the area of contact may have a shape of, for example and without limitation, a rectangle, a rectangle with round corners, or an oval. Thus, in accordance with one or more such embodiments, a geometric center of an area of contact may be aligned over at least a portion of connector 10.

In accordance with one or more embodiments of the present invention, raised reinforcement feature 21 has a height that is greater than a distance between PCB cover 20 and PCB 30 when the disk drive is assembled. As such, as screw 35 (and any other screws) is tightened as described above, a force is transmitted through raised reinforcement feature 21 that ensures robust contacts between spring contacts 11 and contact pads of flex-cable assembly 34 and, thereby, provides reliable electrical connections. As one of ordinary skill in the art can readily appreciate, in any particular embodiment, the height of raised reinforcement feature 21 may be determined by how much force a designer of the disk drive wants PCB cover 20 to deliver to compression connector 10, and the shape and size of raised reinforcement feature 21 may be determined by the location at which the designer wants the force to have effect on compression connector 10. As is well known, different electronic device designs might have different force requirements. As such, the height, shape, and size of raised reinforcement feature 21 for a particular electronic device design may be determined by one of ordinary skill in the art routinely and without undue experimentation utilizing any one of a number of methods that are well known to one of ordinary skill in the art such as, for example and without limitation, finite element analysis. In addition, as should be readily apparent to one of ordinary skill in the art, a further constraint on the design of raised reinforcement feature 21 is that its height, shape, and size ought not to violate form factor constraints of the disk drive. In further addition, raised reinforcement feature 21 may comprise multiple parallel ridges (that are parallel with an orientation of connector 10) or multiple bumps.

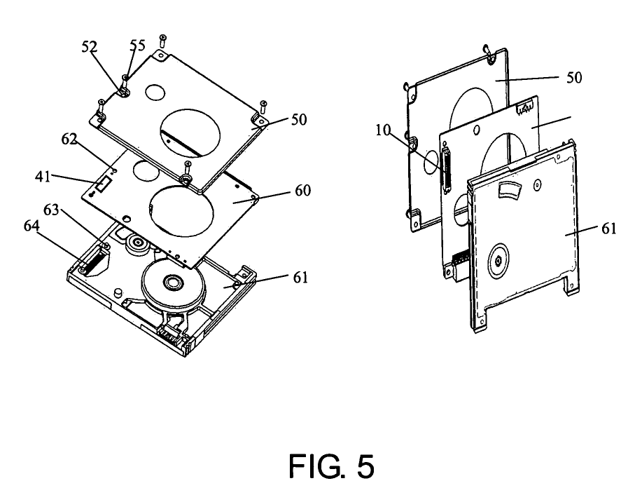

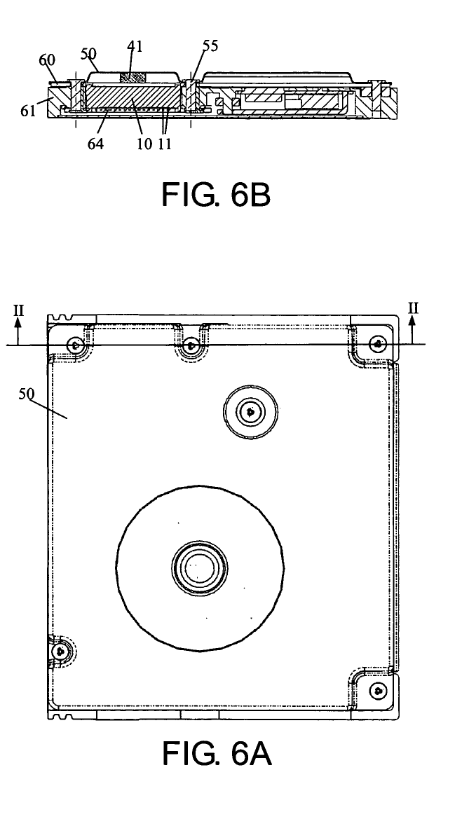

FIG. 5 shows top and bottom perspective exploded views of a disk drive which indicate relative positions of PCB cover 50, PCB 60, reinforcement unit 41 disposed on PCB 60, and HDA 61 of the disk drive, which disk drive is fabricated in accordance with one or more embodiments of the present invention. FIGS. 6A and 6B show a top view and a cross-sectional view, respectively, of an assembly of PCB cover 50, PCB 60, and HDA 61 shown in FIG. 5. In accordance with one or more embodiments of the present invention, whereas raised reinforcement feature 21 described above in conjunction with FIGS. 2-4A is affixed to (and in some embodiments is an extended and integral part of, for example, an extruded part of) PCB cover 20, in accordance with one or more further embodiments of the present invention, reinforcement unit 41 is external to, and forms a part of neither PCB cover 50 nor PCB 60. Further, in accordance with one such embodiment, reinforcement unit 41 is fabricated from a material that is different from that of PCB cover 50 and PCB 60 while in other embodiments it may be fabricated from the same material as PCB cover 50 or PCB 60.

In accordance with one or more embodiments of the present invention, when the disk drive is assembled, at least a portion of reinforcement unit 41 (referred to herein as an area of contact, although it could be several such areas) is aligned to be disposed over at least a portion of connector 10. In particular, in accordance with one or more embodiments of the present invention, the area of contact may have a shape of, for example and without limitation, a rectangle, a rectangle with round corners, or an oval. Thus, in accordance with one or more such embodiments, a geometric center of an area of contact may be aligned over at least a portion of connector 10.

21 In accordance with one or more embodiments of the present invention, reinforcement unit 41 has a height that is greater than a distance between PCB cover 50 and PCB 60 when the disk drive is assembled. As such, as screw 55 (and any other screws) is tightened as described below, a force is transmitted through reinforcement unit 41 that ensures robust contacts between spring contacts 11 and contact pads of flex-cable assembly 64. As one of ordinary skill in the art can readily appreciate, in any particular embodiment, the height of reinforcement unit 41 may be determined by how much force a designer of the disk drive wants PCB cover 50 to deliver to compression connector 10, and the shape and size of reinforcement unit 41 is determined by the location at which the designer wants the force to have effect on compression connector 10. As is well known, different electronic device designs might have different force requirements. As such, the height, shape, and size of reinforcement unit 41 for a particular electronic device design may be determined by one of ordinary skill in the art utilizing any one of a number of methods that are well known to one of ordinary skill in the art such as, for example and without limitation, finite element analysis. In addition, as should be readily apparent to one of ordinary skill in the art, a further constraint on the design of raised reinforcement feature 21 is that its height, shape, and size ought not to violate form factor constraints of the disk drive. In further addition, raised reinforcement feature 21 may comprise multiple parallel ridges or multiple bumps.

In accordance with one or more further embodiments of the present invention, reinforcement unit 41 may be affixed to PCB cover 50 or to PCB 60 using, for example and without limitation, one or more pins or tacks, epoxy, glue, adhesive tape, or a pressure-sensitive adhesive. Further, in accordance with one or more further embodiments of the present invention, reinforcement unit 41 may be inserted between PCB 60 and PCB cover 50 during assembly of the disk drive without being affixed to either PCB 60 or PCB cover 50.

As shown in FIGS. 5 and 6B, in accordance with one or more embodiments of the present invention, PCB 60 is disposed relative to HDA 61 so that connector 10 (on PCB 60) faces flex-cable assembly 64; PCB cover 50 is disposed over PCB 60; and reinforcement unit 41 is affixed to PCB 60 on an opposite side of, and at least partially over, connector 10. As one can appreciate from FIG. 5, to assemble the parts shown therein, screw 55 would be: (a) extended through PCB cover screw hole 52 (in PCB cover 50) and PCB screw hole 62 (in PCB 30); and (b) screwed into HDA screw hole 63 (in HDA 61). As a result, PCB cover 50, PCB 60, and HDA 61 would be fastened together and properly aligned. Hence, as one of ordinary skill in the art can readily appreciate, in accordance with one or more embodiments of the present invention, during assembly of the disk drive, as screw 55 is tightened, it will exert a force on PCB cover 50. Further, PCB cover 50 would be applied to reinforcement unit 41, which is affixed on PCB 60, and as a result, would urge PCB 60 toward HDA 61. Hence, PCB 60 would urge compression connector 10 disposed on the opposite side of PCB 60 towards flex-cable assembly 64 on HDA 61. Thus, in accordance with one or more embodiments of the present invention, a force applied by screw 55 is transmitted by reinforcement unit 41 to PCB 60 at areas of contact between PCB cover 50 and reinforcement unit 41. Without this force, it is believed that spring contacts 11 of compression connector 10 (refer to FIG. 6B) would tend to push compression connector 10 away from flex-cable assembly 64, thereby reducing contact between spring contacts 11 and contact pads of flex-cable assembly 64, and causing unreliable electrical connection.

Although the method of assembling PCB cover 50, PCB 60, and HDA 61 was described above as utilizing one screw and a corresponding set of screw holes, embodiments of the present invention are not limited thereto. For example, in accordance with one or more embodiments of the present invention, and as shown in FIGS. 5, 6A, and 6B, a plurality of screws, screw holes, and screw receptacles (like screw 55, screw holes 52, and 62, and screw receptacle 63) may be used in assembling the disk drive.

Advantageously in accordance with one or more embodiments of the present invention, an electronic device, for example and without limitation, a disk drive, fabricated in accordance with one or more embodiments of the present invention may have a reinforced composite structure as well as reliable electrical connection.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. An electronic device comprising:
a connector;
a contact pad; and
a structure adapted to urge the connector toward the contact pad, wherein at least a portion of the structure is aligned with at least a portion of the connector.

2. The electronic device of claim 1 wherein the connector is disposed on a first side of a printed circuit board, and the structure is disposed on a printed circuit board cover, which printed circuit board cover is disposed over a second side of the printed circuit board.

3. The electronic device of claim 1 wherein the connector is disposed on a first side of a printed circuit board, the structure is disposed on a second side of the printed circuit board, and a printed circuit board cover is disposed over the second side of the printed circuit board.

4. The electronic device of claim 1 wherein the connector is disposed on a first side of a printed circuit board, the structure is an extruded feature of a printed circuit board cover, which printed circuit board cover is disposed over a second side of the printed circuit board.

5. The electronic device of claim 1 wherein the connector is disposed on a first side of a printed circuit board, the structure is an extruded feature of a second side of the printed circuit board, and a printed circuit board cover is disposed over the second side of the printed circuit board.

6. The electronic device of claim 1 wherein the structure comprises steel.

7. The electronic device of claim 1 wherein the structure comprises non-conductive material.

8. The electronic device of claim 1 wherein the structure and the connector are disposed on different sides of a printed circuit board.

9. The electronic device of claim 1 wherein the structure is disposed between a first side of a printed circuit board and a printed circuit board cover; and the connector is disposed on a second side of the printed circuit board.

10. The electronic device of claim 9 wherein the structure is an insert.

12. The electronic device of claim 9 wherein the structure has a height that is larger than a distance between the printed circuit board and the printed circuit board cover.

13. The electronic device of claim 1 wherein the structure comprises an area of contact having a shape of a rectangle.

14. The electronic device of claim 1 wherein the structure comprises an area of contact having a shape of a rectangle with round comers.

15. The electronic device of claim 1 wherein the structure comprises an area of contact having a shape of an oval.

16. The electronic device of claim 1 wherein the structure comprises one or more ridges.

17. The electronic device of claim 16 wherein the one or more ridge structures are parallel with an orientation of the connector.

18. The electronic device of claim 1 wherein the structure comprises one or more bump structures.

19. The electronic device of claim 1 comprising a disk drive.
